(19) United States
(12) Patent Application Publication
(10) Pub. No.: US 2025/0343571 A1
(43) Pub. Date: Nov. 6, 2025

(54) RADIO FREQUENCY TRANSMISSION-RECEPTION DEVICE COMPRISING A FLEXIBLE SUPPORT

(71) Applicant: Primo1D, Grenoble (FR)

(72) Inventor: Idir Raid, Grenoble (FR)

(21) Appl. No.: 18/825,762

(22) Filed: Sep. 5, 2024

(30) Foreign Application Priority Data
May 6, 2024 (FR) 2404725

(51) Int. Cl. H04B 5/48; G06K 19/02; H01Q 1/22; H01Q 7/00

(52) U.S. Cl. CPC H04B 5/48; G06K 19/025; H01Q 1/2225; H01Q 7/00

(57) ABSTRACT

A radio frequency transmission-reception device comprises a flexible support and a radio frequency transmission-reception module integral with the flexible support. The module comprises a first antenna electrically connected to at least one transmit-receive electronic chip. A second antenna formed by an electrically conductive strand is attached to the flexible support. The second antenna can be coupled inductively to the first antenna and comprises at least one textile thread and at least one electrically conductive element wound helically in turns around the textile thread.

### PRIORITY CLAIM

This application claims the benefit of the filing date of French Patent Application Serial No. FR2404725, filed May 6, 2024, for “Radio Frequency Transmission-Reception Device Comprising a Flexible Support.”

### TECHNICAL FIELD

The present disclosure relates to a radio frequency transmission and reception device, such as an RFID label. More particularly, the present disclosure relates to a flexible and robust radio frequency transmission and reception device. Such a device is used for labelling objects, particularly objects that are likely to be deformed, such as textiles or objects made of a deformable material.

### BACKGROUND

Documents US2014291409, US2020117973A, US20240038043 or WO202237900 propose flexible RFID tags for clothing or laundry products. These labels consist of a substrate on which an RFID module is mounted. This module consists of an RFID chip electrically connected to a first “near field” or “magnetic” antenna. A second “far field” or “electrical” antenna, capable of coupling inductively with the first antenna of the RFID module, is assembled, woven or sewn into the flexible support, or more generally held to this support.

As mentioned in FR3036823, this second antenna can be made of stainless steel or copper, typically a wire composed of a plurality of twisted stainless-steel strands or a single-strand copper wire, possibly mixed with polyester or natural fibers.

When this second antenna is made of stainless-steel multi-strand wire, it is particularly rigid and difficult to integrate into a textile substrate. This gives the RFID tag a rigidity that does not make it perfectly suited to integration into very flexible or very light textile parts such as clothing.

When this second antenna is made of a single-strand copper wire, the RFID tag becomes particularly fragile, especially when subjected to mechanical stress during washing cycles of the textile parts in which such a tag is integrated. Under the effect of these stresses, the single-strand wire forming the second far-field antenna is likely to break, rendering the RFID tag non-functional.

### BRIEF SUMMARY

One aim of the present disclosure is to propose a radio frequency transceiver device which addresses these limitations. More specifically, one aim of the present disclosure is to propose a radio frequency transceiver device that is flexible, i.e., that can be folded and collapsed without effort, while still being robust.

With a view to achieving one of these aims, one embodiment of the disclosure includes a radio frequency transceiver device comprising:
flexible support;
a radio frequency transmission-reception module attached to the flexible support and comprising a first antenna electrically connected to at least one electronic transmission-reception chip;
a second antenna formed by an electrically conductive strand secured to the flexible support and capable of coupling inductively to the first antenna, the second antenna comprising at least one textile thread and at least one electrically conductive element wound helically in turns around the textile thread.

According to other advantageous and non-limiting features of the disclosure, taken alone or in any technically feasible combination:
the second antenna is sewn, woven or embroidered into the flexible support or glued to the flexible support;
the second antenna is fitted with a protective sheath;
the protective sheath consists of a protective wire, covered on the electrically conductive side;
the protective sheath is formed of a protective material encapsulating the electrically conductive strand;
the textile yarn has a diameter of between 50 microns and 100 microns;
the textile yarn is made of synthetic fibers such as polyester or polyamide fibers;
the electrically conductive element is a conductive ribbon;
the conductive strip has a thickness of less than 10 microns, preferably less than 5 microns, more preferably less than 3.5 microns or even less than 1.5 microns;
the electrically conductive element is made of a metal or a plurality of metals, such as a copper-silver alloy;
the electrically conductive element is covered with an electrically insulating coating, such as a varnish or enamel;
the radio frequency transceiver module is attached to one side of the flexible support, for example, by way of an adhesive material;
the radio frequency transceiver module is coated with a protective material, such as a resin.

### BRIEF DESCRIPTION OF THE DRAWINGS

Further features and advantages of the present disclosure will be apparent from the detailed description of embodiments of the disclosure that follows with reference to the accompanying figures, in which:

FIG. 1 schematically illustrates a radio frequency transceiver device in accordance with the present disclosure; and

FIG. 2 shows a second antenna of a radio frequency transmission-reception device in accordance with the present disclosure.

### DETAILED DESCRIPTION

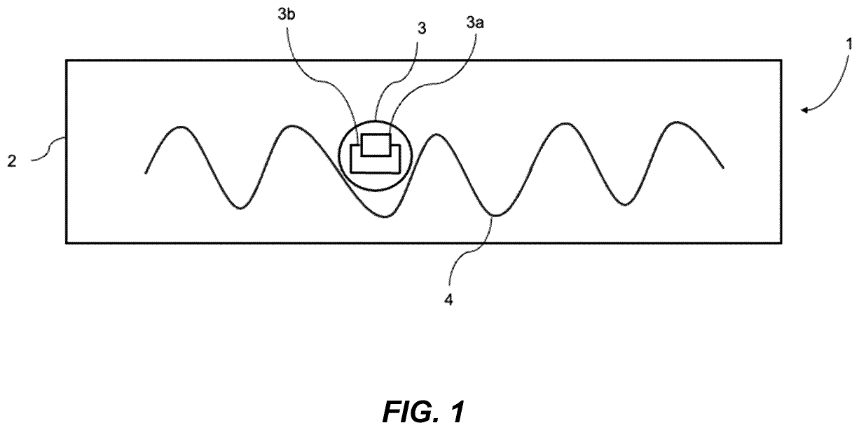

With reference to FIG. 1, a radio frequency transceiver device 1 conforming to the present disclosure comprises a flexible support 2 and a radio frequency transceiver module 3 integral with the flexible support 2.

The flexible support 2 in the example in FIG. 1 is in the form of a strip, but this is not an important feature. It can be made of a plastic or textile material, woven or non-woven, for example, cotton, nylon, polyester, an elastomer or any other synthetic or natural material.

The radio frequency transmit-receive module 3 (referred to more simply as the “RF module” in the remainder of this description) is formed by a first antenna 3b electrically connected (i.e., by a galvanic link) to at least one electronic chip 3a, at at least one contact pad on this electronic chip 3a. The electronic chip 3a may, in particular, be a radio frequency identification (RFID) chip. The electronic chip 3a can be placed on a substrate on which conductive tracks are arranged, with pads on the chip being in contact with these tracks, to form the first antenna 3b. The assembly can be encapsulated in a protective material, such as resin, or placed in a protective case to form the RF module 3. This first antenna 3b forms a “near-field” or “magnetic” antenna, as previously mentioned in the Background.

The RF module 3 is attached to the flexible support 2, for example, by way of an adhesive material. Alternatively to this method of attachment, or in addition to it, the flexible support can be provided with a pocket into which the RF module 3 can be slid to hold it against the flexible support 2. Particularly if the flexible support is in the form of a strip and is sufficiently wide, it may be possible to fold the flexible support 2 on itself to incorporate the RF module between two thicknesses of the flexible support 2. Alternatively, a complementary flexible support can be laminated, sewn or glued onto the flexible support 2 on which the RF module 3 has been placed. In all cases, the RF module 3 is held to the flexible support 2, on one of its faces or integrated into its thickness.

Returning to the description of the device 1 in FIG. 1, it also comprises an electrically conductive strand 4 attached to the flexible support 2. This electrically conductive strand 4 forms a second “far-field” or “electric” antenna, capable of coupling inductively with the first antenna.

The second antenna does not necessarily extend in a straight line over the flexible support 2 and can be integrated into this support in any suitable pattern, in particular to promote its inductive coupling to the first antenna 3b of the RF module, for example, a meandering pattern as shown in FIG. 1. It will generally be sought to position this second antenna 4 and the RF module relatively close together, to obtain effective inductive coupling between the first antenna and the second. To this end, in the example shown in FIG. 1, the RF module 3 has been positioned at the bottom of a loop in one of the meanders of the electrically conductive strand 4 forming the second antenna.

The electrically conductive strand 4 is attached to the flexible support 2, for example, by being sewn, woven, embroidered or glued onto or into the flexible support 2. The operation of securing this strand 4 to the flexible support 2 can be carried out on the flexible support after it has been manufactured, for example, by sewing, weaving, gluing or embroidering a long strand onto a ribbon forming the flexible support, the ribbon being unwound from a reel. The ribbon, provided with the long electrically conductive strand, can then be used to form a plurality of devices 1, before being cut into individual devices. Alternatively, this operation can be carried out simultaneously with the manufacture of the flexible support itself, for example, by weaving or embroidering a long electrically conductive strand during the operation of weaving a ribbon from which a plurality of flexible supports 2 will be extracted.

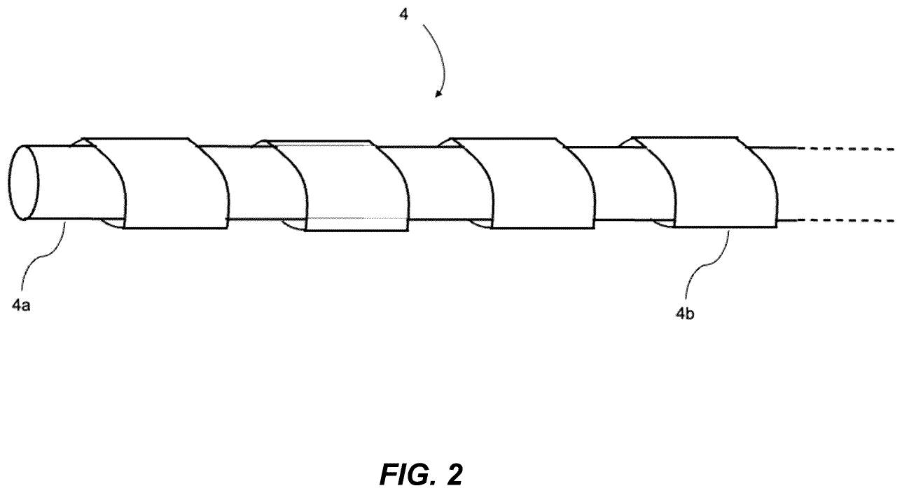

As previously stated herein, the aim is to form a second antenna that is robust, i.e., with high mechanical strength, and flexible, i.e., capable of absorbing tensile, torsional and/or flexural stresses from the flexible support 2 without deteriorating, even when these stresses are repeated, in cycle, many times, for example, during repeated washing cycles. To this end, and according to an important feature of the present description shown in FIG. 2, the electrically conductive strand 4 comprises a textile thread 4a and at least one electrically conductive element 4b wound helically in turns around the textile thread 4a. This electrically conductive element 4b may, in particular, take the form of a conductive wire or a conductive ribbon, this second possibility being shown in FIG. 2.

“Ribbon” refers to an elongated, flexible, flat film. This tape can, for example, be made of rolled metal wire.

Whether in the form of a thread or a ribbon, the electrically conductive element 4b is wound helically against the textile thread 4a, slightly pressed against this thread 4a. It is not necessary to provide any adhesive material between the textile thread 4a and the electrically conductive element 4b.

The textile yarn 4a may be formed from synthetic fibers, such as polyester or polyamide fibers, or from natural fibers. By way of example, the textile yarn may be composed from aramid fibers, and thus form a meta-aramid multi-filament yarn (for example, known under the trade name Nomex™), a short or long meta-aramid fiber yarn, such as a polyamide-imide (for example, known under the trade name Kermel™). Alternatively, it can be a PBO yarn (poly(p-phenylene-2,6-benzobisoxazole), known under the trade name Zylon™. Alternatively, it may be formed from an aromatic polyester (for example, known by the trade name Vectran™). It may also be a yarn formed from a polymer such as PEAK (polyaryletherketones), natural fibers, glass fibers, carbon fibers, PPS (Polyphenylene Sulphide) fibers or steel fibers. In addition to these fibers or as a replacement, the textile yarn 4a may comprise a conductive strand (or a plurality of conductive strands) with a diameter of less than 20 microns. Advantageously, the textile yarn 4a is electrically insulating or only slightly electrically conductive, although this does not rule out the possibility of the textile yarn 4a being conductive. In particular, the textile thread can be metalized, i.e., coated at least partially with a metal layer 4b, to enhance its electrically conductive nature. In this way, electrical continuity can be ensured in the electrically conductive element 4b wound helically against the textile thread 4a.

The textile thread 4a advantageously has a circular or elliptical cross-section. Its diameter (or major axis in the case of an elliptical cross-section) is advantageously between 50 microns and 150 microns, to avoid it being too rigid.

The electrically conductive element 4b, conductive wire or conductive ribbon, can be made of one metal or a plurality of metals, for example, a metal alloy.

The electrically conductive element 4b may be made of or comprise copper, brass, bronze, cupro-nickel, a copper alloy containing more than 96% by mass of copper, nickel or an alloy of copper and silver.

This electrically conductive element 4b may include a main layer or core of a first material, this main layer or core being covered with a conductive coating. For example, the main layer or core may be made of steel coated with a material selected from the group consisting of silver, gold, copper, tin, nickel, brass, zinc and tin alloys. Alternatively, the main layer or core may be made of a material selected from the group consisting of the following materials: stainless steel, a nickel alloy in which nickel alone represents at least 45% of the mass of the alloy, a titanium alloy in which titanium alone represents at least 70% of the mass of the alloy, and nickel.

Advantageously, the coating has a lower electrical resistivity than the material forming the main layer or core. It can be chosen for its anti-corrosion properties, for example, being made of silver.

Alternatively, the coating can be electrically insulating. This could be a varnish or enamel, to protect the electrically conductive strand 4 from its environment, particularly during washing.

The coating, whether electrically conductive or insulating, can be formed by deposition on the main layer or core.

When the electrically conductive element 4b takes the form of a ribbon, it can be made from a laminated conductive wire. In this case, and advantageously, this lamination is carried out cold. Preferably, it is not followed by thermal annealing. This cold lamination process increases the hardening of the material and, therefore, its resistance to fatigue.

Whatever the nature chosen for the electrically conductive element 4b, and to preserve all the flexibility of the textile thread 4a making up the electrically conductive strand 4 and to be wound in turns on this textile thread, the electrically conductive element 4b has a small thickness (in the case of a conductive ribbon) or a small diameter (in the case of a conductive thread), of between 1 micron and 10 microns. Preferably, this thickness is less than 5 microns, more preferably less than 3.5 microns, or even less than 1.5 microns. The electrically conductive element 4b is, therefore, capable of elastic or plastic deformation.

When in the form of a conductive ribbon, the electrically conductive element 4b may have a width of between 40 microns and 200 microns, without this characteristic forming any limitation.

The electrically conductive element 4b can be wound helically in turns around the textile thread 4a in a number of ways. The turns can be non-contiguous, i.e., two successive turns are spaced apart and do not touch each other. Alternatively, they can be wound in contiguous turns or in overlapping turns (in the case of a ribbon). Adjoining turns help to improve the electrical conductivity of the electrically conductive strand 4.

A plurality of electrically conductive elements 4b may also be provided, all helically wound in turns on the textile thread 4a, particularly when these elements are in the form of conductive wires. This improves the mechanical and electrical robustness of the electrically conductive strand 4. In particular, the electrical continuity of the electrically conductive strand 4 is ensured, even after the breakage of one of the electrically conductive elements. In this case, the winding directions may all be identical or they may be different. Furthermore, the electrically conductive elements 4b are made of electrically conductive materials that may all be identical or different.

The relatively small thickness of the electrically conductive element 4b or the diameter of the conductive wire, combined with the textile nature of the textile thread 4a, means that the second antenna 4 is flexible and can, therefore, be elastically or plastically deformed when bent, without breaking.

To improve the robustness of the electrically conductive strand 4, particularly against chemical attack, this electrically conductive strand 4 can be provided with a protective sheath. This sheath can be formed by a protective wire wrapped around the electrically conductive strand. Alternatively, or additionally, this sheath can be formed from a protective material, for example, a resin, such as an epoxy resin, coating the electrically conductive strand 4 or coating the coated protective wire when a coated protective wire is present.

In addition to protection against chemical attack, the protective sheath can help prevent the tape from being torn off when the electrically conductive strand 4 is integrated (sewn, woven, embroidered) into the flexible substrate.

Of course, the disclosure is not limited to the methods of implementation described, and alternative embodiments may be used without departing from the scope of the invention as defined by the claims.

What is claimed is:

1. A radio frequency (RF) transceiver device, comprising:
a flexible support;
a radio frequency transceiver module integral with the flexible support and comprising a first antenna electrically connected to at least one transceiver electronic chip; and
a second antenna formed by an electrically conductive strand integral with the flexible support and configured to be inductively coupled to the first antenna, the second antenna comprising at least one textile thread and at least one electrically conductive element wound helically in turns around the textile thread.

2. The RF transceiver device of claim 1, wherein the second antenna is sewn, woven or embroidered into the flexible support or glued to the flexible support.

3. The RF transceiver device of claim 1, further comprising a protective sheath on the second antenna.

4. The RF transceiver device of claim 3, wherein the protective sheath comprises a protective wire covering the electrically conductive strand.

5. The RF transceiver device of claim 3, wherein the protective sheath comprises a protective material encapsulating the electrically conductive strand.

6. The RF transceiver device of claim 1, wherein the at least one textile thread has a diameter of between 50 microns and 100 microns.

7. The RF transceiver device of claim 1, wherein the at least one textile thread comprises synthetic fibers.

8. The RF transceiver device of claim 7, wherein the synthetic fibers comprise at least one of polyester fibers or polyamide fibers.

9. The RF transceiver device of claim 1, wherein the at least one electrically conductive element comprises a conductive ribbon.

10. The RF transceiver device of claim 9, wherein the conductive ribbon has a thickness of less than 10 microns.

11. The RF transceiver device of claim 10, wherein the conductive ribbon has a thickness of less than 5 microns.

12. The RF transceiver device of claim 11, wherein the conductive ribbon has a thickness of less than 3.5 microns.

13. The RF transceiver device of claim 12, wherein the conductive ribbon has a thickness of less than 1.5 microns.

14. The RF transceiver device of claim 1, wherein the at least one electrically conductive element comprises a metal or metal alloy.

15. The RF transceiver device of claim 14, wherein the at least one electrically conductive element comprises a copper-silver alloy.

16. The RF transceiver device of claim 1, wherein the at least one electrically conductive element is covered with an electrically insulating coating.

17. The RF transceiver device of claim 16, wherein the electrically insulating coating comprises a varnish or enamel.

18. The RF transceiver device of claim 1, wherein the radio frequency transceiver module is integral with one face of the flexible support.

19. The RF transceiver device of claim 18, wherein the radio frequency transceiver module is coated with a protective material.

20. The RF transceiver device of claim 19, wherein the protective material comprises a resin.
